(19) United States
(12) Patent Application Publication
(10) Pub. No.: US 2011/0066512 A1
(43) Pub. Date: Mar. 17, 2011

(54) Applications of Stored Value Card

(76) Inventor: Lars O. Kanngard, Dubai (UA)

(21) Appl. No.: 12/764,926

(22) Filed: Apr. 21, 2010

Related U.S. Application Data
(60) Provisional application No. 61/171,244, filed on Apr. 21, 2009.
(60) Provisional application No. 61/171,239, filed on Apr. 21, 2009.
(60) Provisional application No. 61/171,246, filed on Apr. 21, 2009.
(60) Provisional application No. 61/171,235, filed on Apr. 21, 2009.

(51) Int. Cl. G06Q 40/00

(52) U.S. Cl. 705/16

(57) ABSTRACT

Methods and systems for secure transactions.

### CROSS-REFERENCE

Priority is claimed from U.S. Provisional application 61/092,433 filed Aug. 28, 2008, which is hereby incorporated by reference in its entirety.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 schematically shows information flows in a sample transaction, where a Customer card is interfacing to a Merchant card.

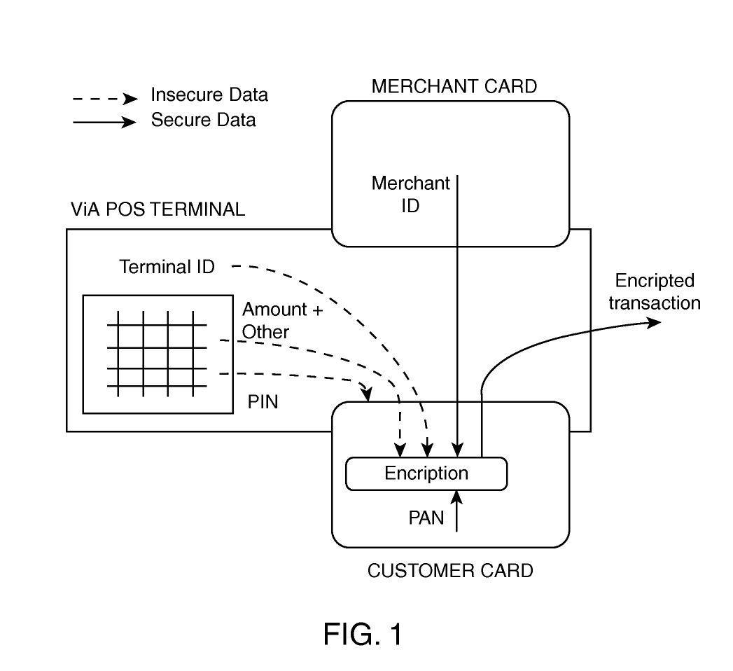

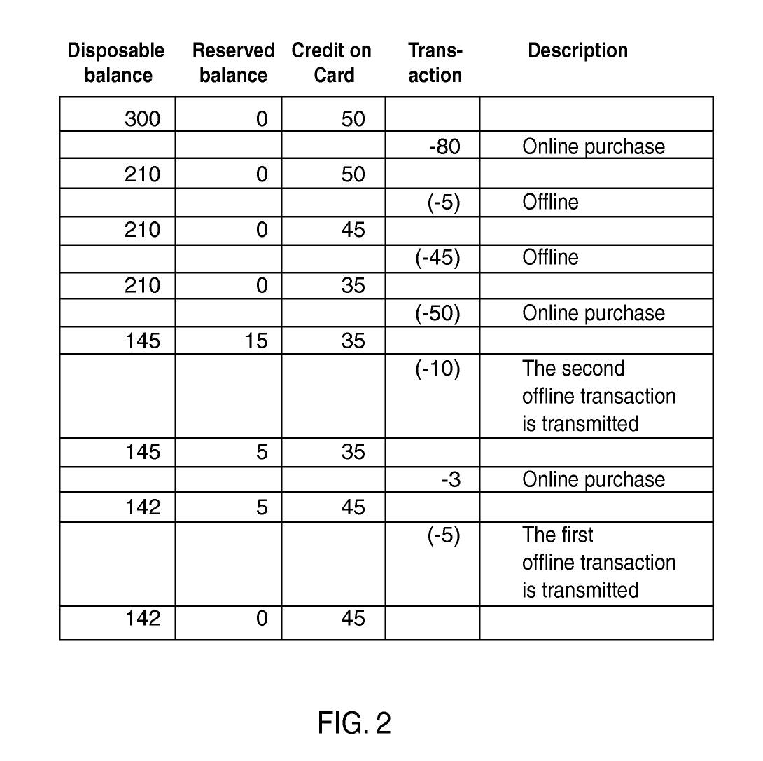

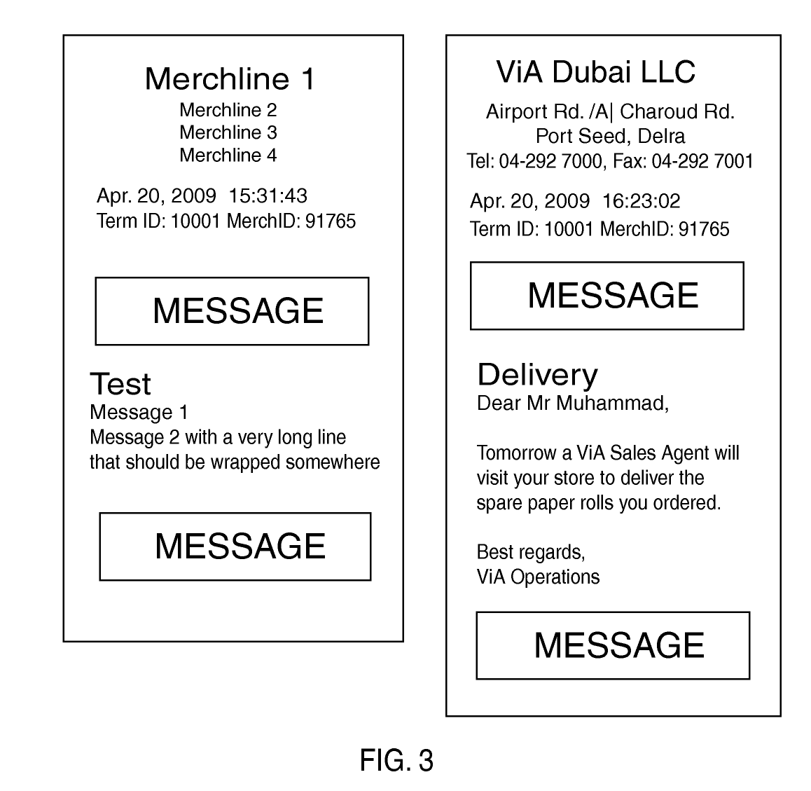

Other Figures are described below.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

Additional descriptive matter, including modifications, improvements, and implementation details, can be found in one or more of the following U.S. patent applications, each of which is hereby incorporated by reference in its entirety:
a. Pending Ser. No. 11/490,489, filed Jul. 20, 2006, and now published as US2007-0033149;
b. Pending 61/171,235 filed Apr. 21, 2009;
c. Pending 61/171,239 filed Apr. 21, 2009;
d. Pending 61/171,244 filed Apr. 21, 2009; and
e. Pending 61/171,246 filed Apr. 21, 2009.

This document describes the whys and hows of how ViA envisions the way of creating a more secure transaction on a POS device.

The rationale behind this model is the assumption that the POS terminal is compromised but we still want to be able to make a transaction as secure as possible.

This is in contrast to the current PCI-DSS and EMV standards where a lot of work is put into making the POS terminal very secure thus increasing the complexity and design of the POS itself.

By assuming that the terminal and other links in the chain towards the processing center is compromised either on a hardware- or software-level we quickly realized that we need to move as much cardholder data, request building and encryption as possible out of the terminal and into to the card itself.

By doing this a compromised terminal can't do much harm on a large scale and a compromised card could only affect one single cardholder.

The Secure Transaction String concept (“STS”) is described in US2007-0033149, and was invented to solve the problem of sharing too much information between the parties involved in POS transaction in the current networks. There are several gateways, processing & fraud detection centers involved while the transaction is en route to the issuing bank for the authorization.

By dividing the data to be sent into several blocks, each encrypted with a separate key, one can reduce the amount of information sharing and possible attack points in the chain. For instance the first link in the chain only needs to know enough of the card number to deduce where to route the rest of the information, the rest of the information will still be encrypted by other keys that the first link doesn't have access to. If this link is compromised, or against the rules stores all transactions locally unencrypted, the other blocks are still encrypted and secure.

In the case of the “ViA Method” described in this document we are not trying to retrofit a legacy network with a secure method. We are creating something new that fits into our business model. We will not have a chain of parties involved in the transaction, no external gateways that need to route the transactions, no processing outside our own network. It will all be handled by us. Thus the STS is really not applicable to us when we're doing it the ViA way.

Alternatively, STS techniques can be combined with the techniques in the present application.

### Information Flow During a Transaction

The normal flow of information is like the following;
1. The transaction type and amount is entered by the merchant
2. The customer smartcard is inserted
3. The customer smartcard is opened by the pin code
4. The terminal helps the merchant- and the customer smartcards to negotiate a session encryption key
5. The terminal retrieves the encrypted merchant id from the merchant smartcard.
6. The terminal sends the amount and a opaque block of information consisting of among other things the terminal id, the encrypted merchant id, the transaction code to the customer smartcard.
7. The customer smartcard retrieves the PAN from itself
8. The customer smartcard encrypts all of this using its private RSA key into a message and delivers it to the terminal. The message needs to have an unencrypted header with a card reference number so the datacenter can decrypt it using the public RSA key belonging to the card.
9. The terminal send the message as-is to the datacenter for processing.

There are some additional functions that can also be implemented on the cards:

A. Customer Card—PIN Replacement

This function is rather self-explanatory. It allows the user to change the PIN on the card.

B. Customer Card—Adjust Off-Line Credit Value

This should probably be a suite of functions to handle the updates of the off-line credit.

The off-line credit is used to allow for some low value purchases to be accepted even if the terminal is temporarily off-line with the processing center.

The terminal will accept the transaction and store the encrypted transaction in the blob storage area of the merchant smartcard. All of these pending transactions are sent for processing at when the terminal is on-line again.

Whenever an off line transaction is taking place the off-line credit value on the customer card should be reduced so it's not possible to make an infinite number of off-line transactions.

When the card is used the next time in a normal on-line situation the credit value will be adjusted with the off-line amount(s) that has been received by the processing center during the period.

FIG. 2 is a table which illustrates important concepts:

Please note that this is not the same thing as a wallet on the card. A wallet usually means that funds must be transferred in advance from the customer account thus reducing the balance of the account. A wallet is also meant to be used in a non-error situation, this in contrast to this credit functionality that's created as a means for our customers to make a transaction even if the processing center or communications links are temporarily down.

As in all cases of credit there will be a risk of non-payment. But by keeping the credit limit adjusted as it's used on the card and by also reducing the limit when the card is made in an online transaction and the account balance is lower than the card credit the risk are kept in control as far as possible.

(Note—This needs more analysis to determine how to handle this in a secure way so deliberate misuse of the function can be avoided.)

C. Merchant Card—Blob Storage and Retrieval

This is a function that allows the terminal to store opaque information blocks on the merchant card. It's planned to be used for two purposes.
1. To store the encrypted transactions being made when the terminal is off-line.
2. To store questionnaires and other information being sent to the merchant for later usage.

It's better to store this kind of information on the merchant smartcard instead of storing it in the file system of the terminal itself since the information will not get lost if the terminal is to be replaced.

### Modifications and Variations

As will be recognized by those skilled in the art, the innovative concepts described below can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

We claim:

1. A POS alert system, comprising:
POS terminal that delivers an alert message to a target receiver during a card transaction.

2. Any device, method and/or apparatus as described in any part of the accompanying patent application.

3. Any device, method and apparatus as exactly described in the accompanying patent application.
